(19) United States
(12) Patent Application Publication
(10) Pub. No.: US 2025/0141132 A1
(43) Pub. Date: May 1, 2025

(54) STAGGERED PIN CONNECTOR

(71) Applicant: Molex, LLC, Lisle, IL (US)

(72) Inventors: Johnny Chen, Milpitas, CA (US); Jacob Alexander Fronberry, Lisle, IL (US); Harold Keith Lang, Lisle, IL (US); David P. Rooney, Lisle, IL (US)

(21) Appl. No.: 18/916,737

(22) Filed: Oct. 16, 2024

Related U.S. Application Data
(60) Provisional application No. 63/593,657, filed on Oct. 27, 2023.

(51) Int. Cl. H01R 12/52; H01R 12/58; H01R 24/64

(52) U.S. Cl. CPC H01R 12/523; H01R 12/58; H01R 24/64; H01R 2201/04

(57) ABSTRACT

A substrate includes a first edge and a second edge opposite the first edge. A plurality of first edge pins are positioned proximate the first edge, where a first subset of the first edge pins is positioned at a first distance from the first edge, and a second subset of the first edge pins is positioned at a second distance from the first edge different than the first distance. A plurality of second edge pins are positioned proximate the second edge, where a first subset of the second edge pins is positioned at a first distance from the second edge, and a second subset of the second edge pins is positioned at a second distance from the second edge different than the first distance, thereby providing a connector having a staggered pin arrangement.

### BACKGROUND

Magnetic jacks, modular jacks (modjacks), and like connectors include one or more ports capable of receiving an Ethernet connection, for instance, using an RJ-11 or RJ-45 connector. The magnetic jacks, modular jacks, and similar connectors include various circuit boards, printed circuit boards (PCBs), integrated circuits (ICs), or like substrates positioned proximate to one another that utilize magnetics and circuitry for processing signals and/or power (e.g., power-over-ethernet or PoE) transmitted through a connector. The proximity of conductive substrates in the connector creates alien near-end crosstalk (NEXT), among other potential types of signal interference. In data speeds of 1 GbE and lower, alien near-end crosstalk usually has minimal effect on data transmissions. However, as data speeds are increasing (e.g., 2.5 GbE, 5 GbE, 10 GbE, and above), alien near-end crosstalk can impede data signal integrity and impair performance of an Ethernet-enabled device.

### SUMMARY

Various embodiments are disclosed for a connector having a staggered pin arrangement for improved performance. In a first aspect, a connector is described, including: a plurality of substrates positioned proximate to one another, where at least one of the plurality of substrates includes: a first edge and a second edge opposite the first edge; a plurality of first edge pins positioned proximate the first edge, where a first subset of the first edge pins is positioned at a first distance from the first edge, and a second subset of the first edge pins is positioned at a second distance from the first edge different than the first distance; and a plurality of second edge pins positioned proximate the second edge, where a first subset of the second edge pins is positioned at a first distance from the second edge, and a second subset of the second edge pins is positioned at a second distance from the second edge different than the first distance.

At least one of the plurality of substrates is a printed circuit board (PCB). Each pin in the first subset of the first edge pins has a diameter less than that of each pin in the second subset of the first edge pins. Each pin in the first subset of the second edge pins has a diameter greater than that of each pin in the second subset of the second edge pins. Each pin of the first edge pins and the second edge pins is positioned within a through-hole.

The connector can further include a first plurality of through-holes positioned proximate the first edge having a first diameter, where the first subset of the first edge pins is positioned within the first plurality of through-holes, and a second plurality of through-holes positioned proximate the first edge having a second diameter different than the first diameter, where the second subset of the first edge pins is positioned within the second plurality of through-holes.

In further aspects, the connector can further include a first plurality of through-holes positioned proximate the second edge having a first diameter, where the first subset of the second edge pins is positioned within the first plurality of through-holes, and a second plurality of through-holes positioned proximate the second edge having a second diameter different than the first diameter, where the second subset of the second edge pins is positioned within the second plurality of through-holes.

The connector can further include a plurality of port terminals coupled to the substrate configured to engage with a housing of an external connector. Each of the plurality of substrates can include electrical traces coupled to one of the plurality of port terminals, where the first edge pins and the second edge pins couple the electrical traces to downstream magnetics. A number of the plurality of port terminals can be four, six, or eight, and the external connector can be an RJ-45 connector.

Each pin of the first subset of the first edge pins can have a first predetermined offset relative to each pin of the second subset of the first edge pins, where the first predetermined offset is a predetermined distance chosen for optimal performance, and each pin of the first subset of the second edge pins can have a second predetermined offset relative to each pin of the second subset of the second edge pins, where the second predetermined offset is a predetermined distance chosen for optimal performance.

In a second aspect, a connector is described, including: a plurality of substrates positioned proximate to one another, where at least one of the plurality of substrates includes: a first edge and a second edge opposite the first edge; and a plurality of first edge pins positioned proximate the first edge, where a first subset of the first edge pins is positioned at a first distance from the first edge, and a second subset of the first edge pins is positioned at a second distance from the first edge different than the first distance.

The connector can further include a plurality of second edge pins positioned proximate the second edge, where a first subset of the second edge pins is positioned at a first distance from the second edge, and a second subset of the second edge pins is positioned at a second distance from the second edge different than the first distance. At least one of the plurality of substrates can be a printed circuit board (PCB).

Each pin in the first subset of the first edge pins can have a diameter less than that of each pin in the second subset of the first edge pins. Each pin in the first subset of the second edge pins can have a diameter greater than that of each pin in the second subset of the second edge pins. Each pin of the first edge pins and the second edge pins can be positioned within a through-hole.

The connector can further include a first plurality of through-holes positioned proximate the first edge having a first diameter, where the first subset of the first edge pins is positioned within the first plurality of through-holes, and a second plurality of through-holes positioned proximate the first edge having a second diameter different than the first diameter, where the second subset of the first edge pins is positioned within the second plurality of through-holes.

In some aspect, the connector can further include a first plurality of through-holes positioned proximate the second edge having a first diameter, where the first subset of the second edge pins is positioned within the first plurality of through-holes, and a second plurality of through-holes positioned proximate the second edge having a second diameter different than the first diameter, where the second subset of the second edge pins is positioned within the second plurality of through-holes.

The connector can further include a plurality of port terminals coupled to the substrate configured to engage with a housing of an external connector. Each of the plurality of substrates can include electrical traces coupled to one of the plurality of port terminals, where the first edge pins and the second edge pins couple the electrical traces to downstream magnetics. A number of the plurality of port terminals can be four, six, or eight, and the external connector can be an RJ-45 connector. Each pin of the first subset of the first edge pins can have a first predetermined offset relative to each pin of the second subset of the first edge pins, where the first predetermined offset is a predetermined distance chosen for optimal performance, and each pin of the first subset of the second edge pins can have a second predetermined offset relative to each pin of the second subset of the second edge pins, where the second predetermined offset is a predetermined distance chosen for optimal performance.

In a third aspect, a connector is described that includes a substrate, the substrate includes a plurality of first edge pins positioned proximate a first edge is a staggered arrangement, where a first subset of the first edge pins is positioned at a first distance from the first edge, and a second subset of the first edge pins is positioned at a second distance from the first edge different than the first distance.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top perspective view of a connector according to various embodiments of the present disclosure.

FIG. 2 is a bottom perspective view of the connector of FIG. 1 according to various embodiments of the present disclosure.

FIG. 3 is a front elevation view of the connector of FIG. 1 according to various embodiments of the present disclosure.

FIG. 4 is a rear elevation view of the connector of FIG. 1 according to various embodiments of the present disclosure.

FIG. 5 is a top perspective view of the connector of FIG. 1 with its housing omitted according to various embodiments of the present disclosure.

FIG. 6 is a bottom perspective view of the connector of FIG. 1 with its housing omitted according to various embodiments of the present disclosure.

FIG. 7 is a top plan view of a substrate of the connector of FIG. 1 according to various embodiments of the present disclosure.

FIG. 8 is a pin diagram of a substrate of the related art.

FIG. 9 is a pin diagram of a substrate of the connector of FIG. 1 according to various embodiments of the present disclosure.

### DETAILED DESCRIPTION

The present disclosure relates to a connector having a staggered pin arrangement for improved performance, as will be described. The Jack-45 connector, also referred to commonly as an RJ-45 connector, is a wired connector that interfaces with network-enabled devices on a local area network (LAN) including, but not limited to, Ethernet. The RJ-45 connector generally includes a male plug that is plugged or otherwise positioned into a female port. The RJ-45 connector includes a housing having an array of parallel electrical contacts for mating with a port having correspondingly aligned electrical contacts. A spring or tab positioned on the housing is used for coupling the RJ-45 connector with a corresponding plug in a biased and interference manner.

As noted above, a proximity of PCBs or other substrate in a connector having a multitude of plugs, including but not limited to an Ethernet jack or plug, can create alien near-end crosstalk (NEXT). The alien near-end crosstalk can cause undesirable interference in data communication signals. While the alien near-end crosstalk does not tend to interfere with data speeds, power, or data transmissions in lower speeds, due to recent increases in data speeds (e.g., 2.5 GbE, 5 GbE, 10 GbE, and above), alien near-end crosstalk can impede signal integrity and impair signal or power performance of a device utilizing the connector, especially in high data speed applications.

A common way of addressing alien near-end crosstalk in a connector includes positioning a metallic and conductive shield between adjacent terminal box assemblies (TBAs). Each TBA contains two ports, namely, an upper port and a lower port. The PCB in each assembly routes to the magnetics for the upper and lower port. The positioned metallic and conductive shield is typically placed between each assembly spanning most of, if not the entire height of, the TBA in order to decrease alien near-end crosstalk from the entire TBA including the magnetics of the device and the pins within the substrate. Although this shield can improve signal performance, it increases the material required and difficulty to manufacture, thus increasing the overall cost for the connector.

Accordingly, various embodiments are described herein for a connector having a staggered pin arrangement for improved signal and power performance. The connector, which can include an Ethernet or modjack connector, has a multitude of substrates positioned proximate to one another, for instance, in a horizontal side-by-side arrangement. One or more of the substrates includes a first edge and a second edge opposite the first edge, first edge pins positioned along the first edge, and second edge pins positioned along the second edge.

Additionally, in various embodiments, a single continuous substrate can be employed that can be used for horizontally side-by-side TBAs. In this case the first edge pins and second edge pins from one TBA to the adjacent TBA are the distances of concern since there are no substrate edges between the TBAs.

A first subset of the first edge pins can be positioned at a first distance from the first edge. Likewise, a second subset of the first edge pins can be positioned at a second distance from the first edge different than the first distance, thereby providing a staggered arrangement along the first edge. Similarly, second edge pins can be positioned proximate the second edge, where a first subset of the second edge pins can be positioned at a first distance from the second edge, and a second subset of the second edge pins can be positioned at a second distance from the second edge different than the first distance. Thus, a staggered arrangement along the second edge is provided.

One or more of the substrates in the connector can include a circuit board, a printed circuit board (PCB), an integrated circuit (IC), or like substrate. In some embodiments, each pin in the first subset of the first edge pins can have a diameter greater than that of each pin in the second subset of the first edge pins. Similarly, in some embodiments, each pin in the first subset of the second edge pins can have a diameter greater than that of each pin in the second subset of the second edge pins.

The substrate can further include first through-holes, each having a first diameter. The first subset of the first edge pins can be positioned within the first through-holes. The substrate can further include second through-holes, each having a second diameter different than the first diameter. The second subset of the first edge pins can be positioned within the second through-holes. By virtue of the staggered arrangement of pins along edges of the substrate, a distance between pins on adjacent substrates is increased, reducing alien near-end crosstalk and increasing performance, especially at high data speeds.

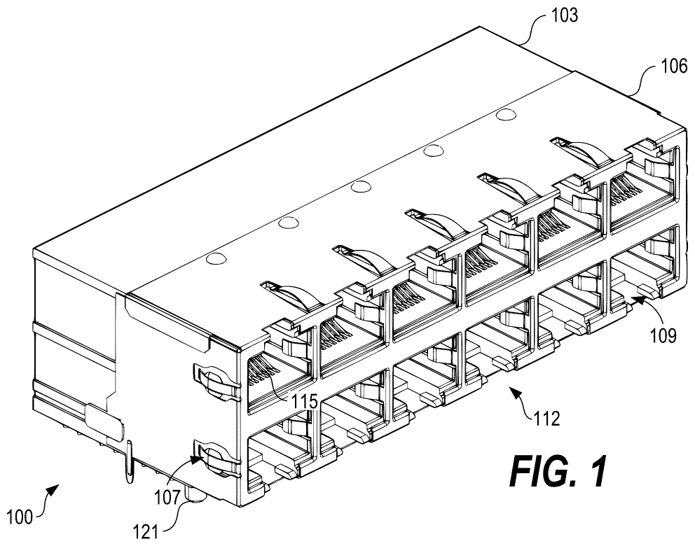

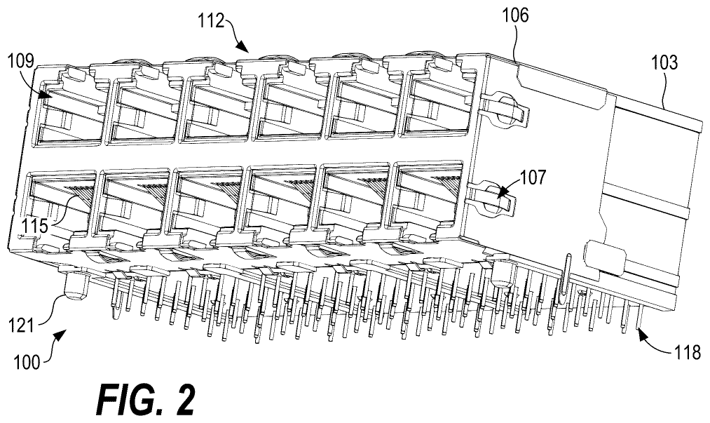

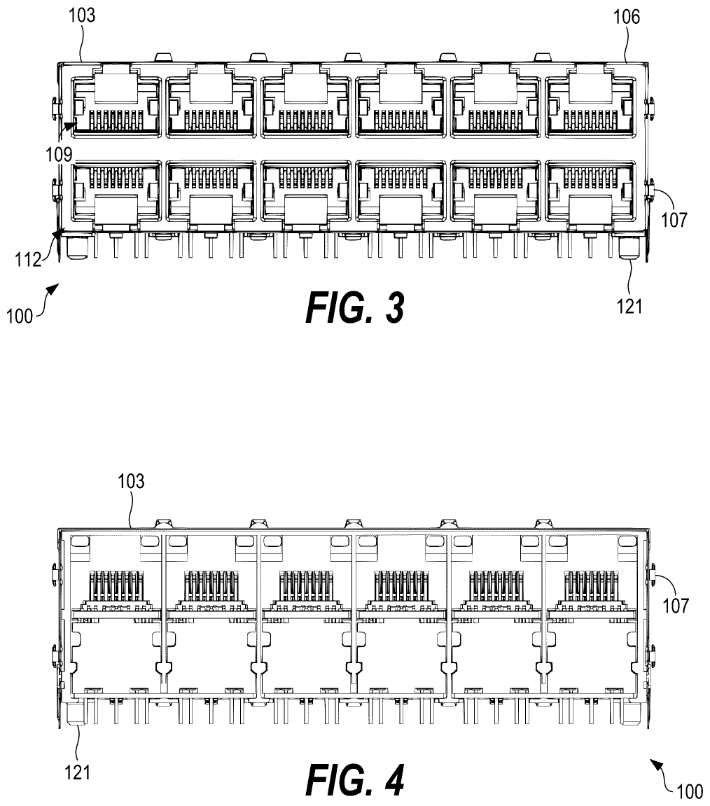

Turning now to the drawings, FIG. 1 shows a top perspective view, FIG. 2 shows a bottom perspective view, FIG. 3 shows a front view, and FIG. 4 shows a rear view of a connector 100, respectively, according to various embodiments of the present disclosure. The connector 100 can be coupled to or positioned with an electronic device to make the device a network-enabled device, as can be appreciated. Thus, the connector 100 can be referred to as a network connector, an Ethernet connector, or like name. The connector 100 also can include a magnetic jack, modjack, or like connector. In some embodiments, the connector 100 is IEEE® 802.3 Ethernet 10/100/1000 compatible; IEEE® 802.3at (PoE Plus) compatible; and/or IEEE® 802.3af (PoE Ethernet) compatible.

Referring to FIGS. 1-4 collectively, the connector 100 can include a housing 103 and a housing shield 106 together defining a multitude of ports 109 positioned on a front face 112 of the connector. The ports 109 are capable of receiving a suitable connector, such as an RJ-45 connector, although other types of connectors are intended to be within the scope of the present disclosure. Although two rows and six columns of ports 109 are shown, it is understood that the connector 100 can include one or more ports 109 in various embodiments.

The housing 103 can be formed of a non-conductive material, such as plastic, although other materials can be employed. Likewise, the housing shield 106 can be formed of a metallic conductive material, such as aluminum, although other materials can be employed, providing a shielding effect. The housing shield 106 can be formed with spring fingers 107 and/or other tabs for engaging and securing various components together when the connector 100 is placed into position, for instance, in a larger housing (not shown), such as a housing of an electronic device.

Each port 109 of the connector 100 can include port terminals 115 configured to make electrical contact with corresponding contacts on a mating plug (e.g., an RJ-45 connector) when inserted therein. A number of the port terminals 115 in each port 109 can vary depending on the type of connector. Some example configurations include four, six, or eight port pins for Ethernet and RJ-45 connectors. In the particular embodiment shown in FIGS. 1-4, eight port terminals 115 are shown, although other numbers of port terminals 115 can be implemented.

The connector 100 can convert data signals transmitted serially to an Ethernet signal, which can be transmitted to downstream circuitry (e.g., a motherboard, PCB, or other device) through board-mount terminals 118 by positioning the connector 100 on a surface-mount device (not shown) and soldering or otherwise affixing the connector 100 to a desired substrate via corresponding through-holes. In some embodiments, the board-mount terminals 118 can extend from or through the housing 103 in a downward direction, as shown in FIG. 2. It is understood, however, that other arrangements can be employed.

According to various embodiments, the connector 100 can include support posts 121, that may retain the housing 103 a predetermined distance from the surface-mount device. The support posts 121 can be formed of a non-conductive material, such as a polymer material. In some implementations, the support posts 121 can be positioned in corresponding apertures located on the surface-mount device.

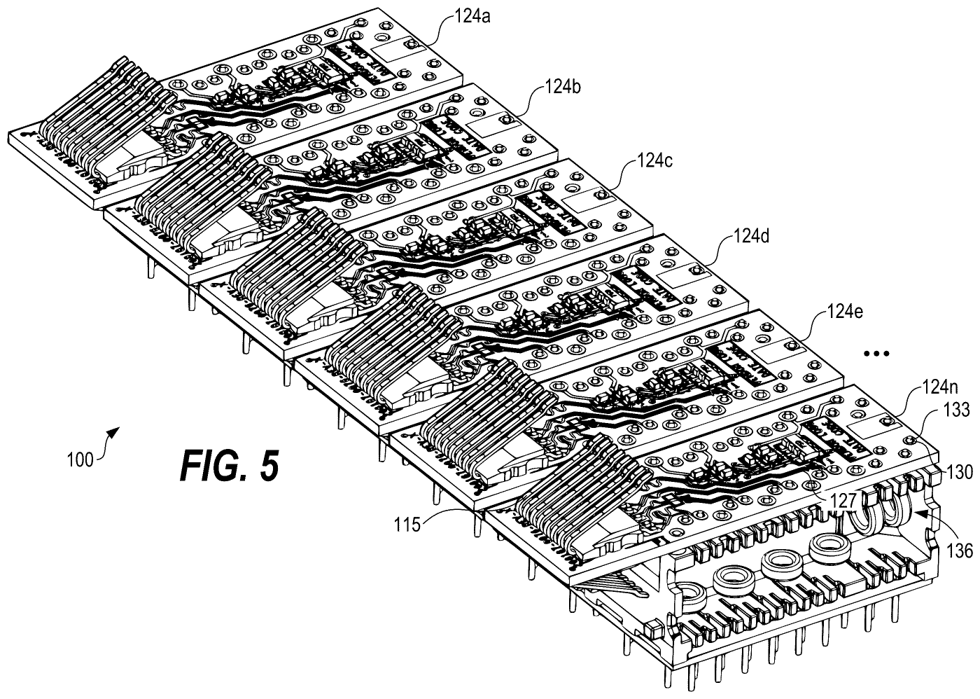

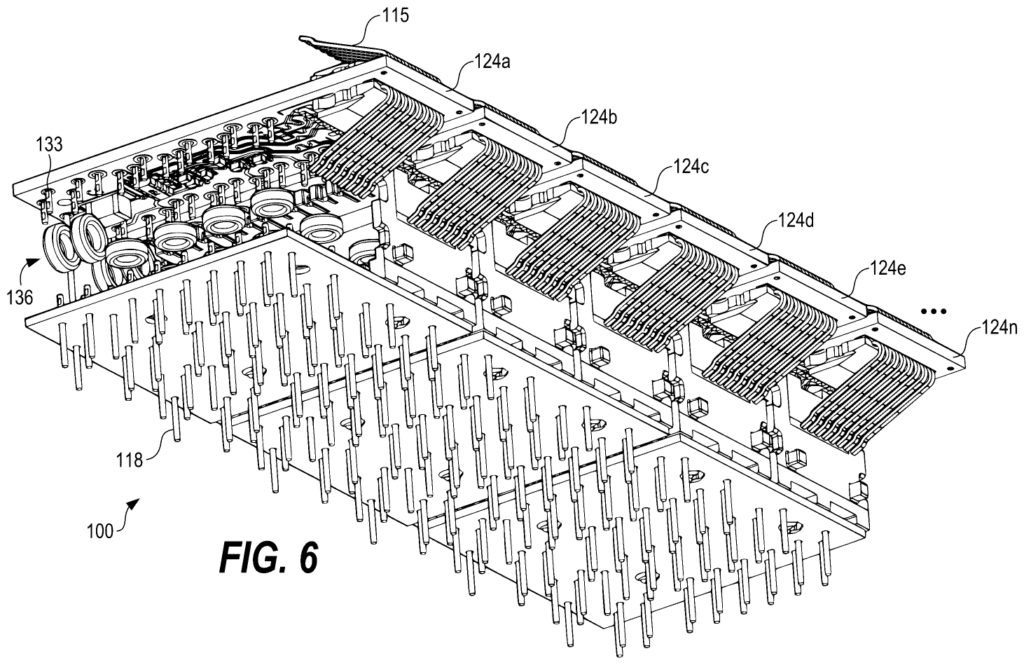

Moving along, FIGS. 5 and 6 show a top perspective view and a bottom perspective view of the connector 100, respectively, with the housing 103 and the housing shield 106 omitted for explanatory purposes. Within the housing 103, the connector 100 can include a multitude of substrates 124a . . . 124n (collectively “substrates 124”) on which the port terminals 115 can be affixed. The substrates 124 can further include electrical traces 127, through-holes 130, pins 133, and other components, as can be appreciated, as best seen in the top perspective view of FIG. 5. Other components that can be formed or otherwise included on the substrate 124 can include active or passive components, such as inductors and capacitors, light-emitting diodes (LEDs), and other components. The port terminals 115 are coupled to the electrical traces 127 on each substrate 124, where the pins 133 couple the electrical traces 127 to magnetics 136 or other downstream electronics of the connector 100. The magnetics 136, for example, provide signal isolation, impedance matching, signal transformation, surge protection, and other functions, thereby providing a signal via the board-mount terminals 118.

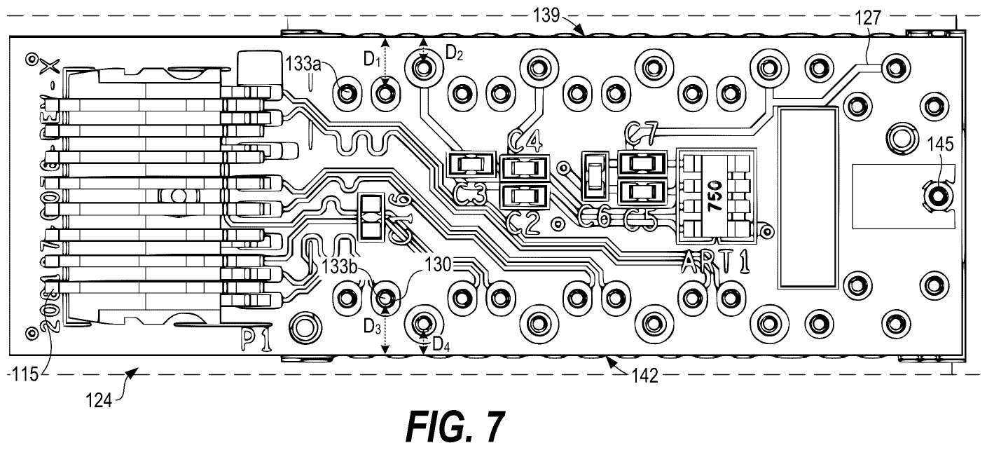

Referring next to FIG. 7, FIG. 7 shows a top view of a representative substrate 124 of the connector 100, again with the housing 103 and the housing shield 106 omitted for explanatory purposes. As shown in FIG. 5, the substrate 124 can be positioned proximate to other substrates 124. For instance, the substrates 124 can be arranged horizontally, where each of the substrates 124 in a particular row are positioned along a same plane in a side-by-side configuration. Referring again to FIG. 7, the substrate 124 can include a first edge 139 and a second edge 142 opposite the first edge 139. For instance, the first edge 139 and the second edge 142 are on opposing sides of the substrate 124.

First edge pins 133a are positioned along or proximate the first edge 139. For instance, the first edge pins 133a are closer to the first edge 139 than the second edge 142. A first subset of the first edge pins 133a are positioned at a first distance D₁ from the first edge 139, and a second subset of the first edge pins 133a are positioned at a second distance D₂ from the first edge 139. In various embodiments, the second distance D₂ is different than the first distance D₁, thus providing a staggered arrangement of the first edge pins 133a, illustrated in FIG. 7. Notably, pairs of first edge pins 133a, as shown in FIG. 7, have a longer distance to the first edge 139 (D₁) as opposed to isolated first edge pins 133a, which are positioned closer to the first edge 139 (D₂) (although other staggered arrangements are possible).

Second edge pins 133b are positioned along or proximate the second edge 142. For instance, the second edge pins 133b are closer to the second edge 142 than the first edge 139, as can be observed from FIG. 7. Like the first edge pins 133a described above, a first subset of the second edge pins 133b are positioned at a first distance D₃ from the second edge 142, and a second subset of the second edge pins 133b are positioned at a second distance D₄ from the second edge 142, where the second distance D₄ is different than the first distance D₃.

A staggered arrangement of the second edge pins 133b are thus shown along the second edge 142. For instance, pairs of second edge pins 133b, shown in FIG. 7, have a longer distance to the second edge 142 as opposed to isolated second edge pins 133b, which are positioned closer to the second edge 142. It is understood, however, that isolated ones of the second edge pins 133b can be positioned farther from the second edge 142 than pairs of second edge pins 133b in alternative staggered arrangements. Notably, not all of the first edge pins 133a are aligned along a common axis positioned parallel to the first edge 139, and/or not all of the first edge pins 133a are aligned along a common axis positioned parallel to the second edge 142.

Further, in some embodiments, each pin 133 in the first subset of the first edge pins 133a can have a diameter less than that of each pin 133 in the second subset of the first edge pins 133a. For instance, the first edge pins 133a arranged in pairs along a horizontal direction of the substrate 124 have a diameter smaller than that of the isolated ones of the first edge pins 133a that are positioned closer to the first edge 139. In some implementations, the diameters are not different from one another. As the pins 133 are offset, pads on larger pins can be of a standard size instead of a unique oval shape that may not connect to the through-hole 130 on all sides.

Similarly, in some embodiments, each pin 133 in the first subset of the second edge pins 133b can have a diameter less than that of each pin 133 in the second subset of the second edge pins 133b. For instance, the second edge pins 133b arranged in pairs along a horizontal direction of the substrate 124 have a diameter smaller than that of the isolated ones of the second edge pins 133b that are positioned closer to the second edge 142. A ground pin 145 can be positioned at a distal end of the substrate 124 opposite that of the port terminals 115.

Each pin 133 of the first edge pins 133a and/or the second edge pins 133b can positioned within through-holes 130, permitting the pin 133 to couple an electrical trace 127 to magnetics 136 or other downstream portion of the connector 100. In some embodiments, a first group of the through-holes 130 have a first diameter, where the first subset of the first edge pins 133a are positioned within the first group of through-holes 130, and a second group of through-holes 130 have a second diameter different than the first diameter. The second subset of the first edge pins 133a can be positioned within the second group of through-holes 130.

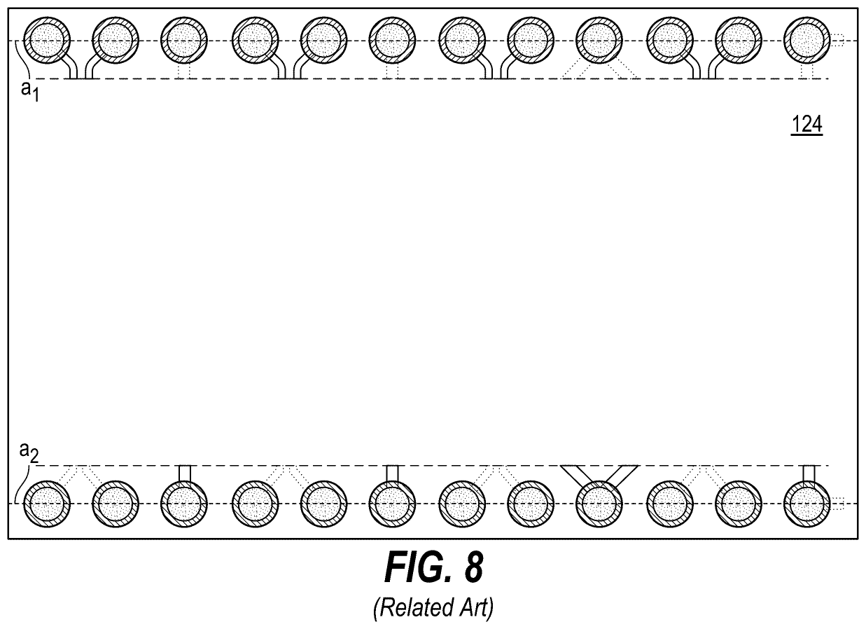

Turning next to FIG. 8, FIG. 8 shows a pin diagram of an example substrate 124 of the related art. As can be seen, all of pins located along a first side of the substrate are aligned along a common axis a positioned parallel to the first side. All of the pins located along a second side of the substrate are aligned along a common axis a₂ positioned parallel to the second side. Additionally, each of the pins, whether on the first side or the second side, are of a uniform size positioned in through-holes also of a uniform size. It is understood that, when multiple substrates 124 of the related art are positioned adjacent one another, or even stacked in a vertical arrangement on top of one another, a proximity of pins between adjacent substrates 124 creates alien near-end crosstalk, which impairs the ability of transmitting at high data speeds, especially for 2.5 GbE and above. In the related art, it was difficult and undesirable to move the locations of the pins, as such movement of the pins could interfere with trace routing, among other difficulties.

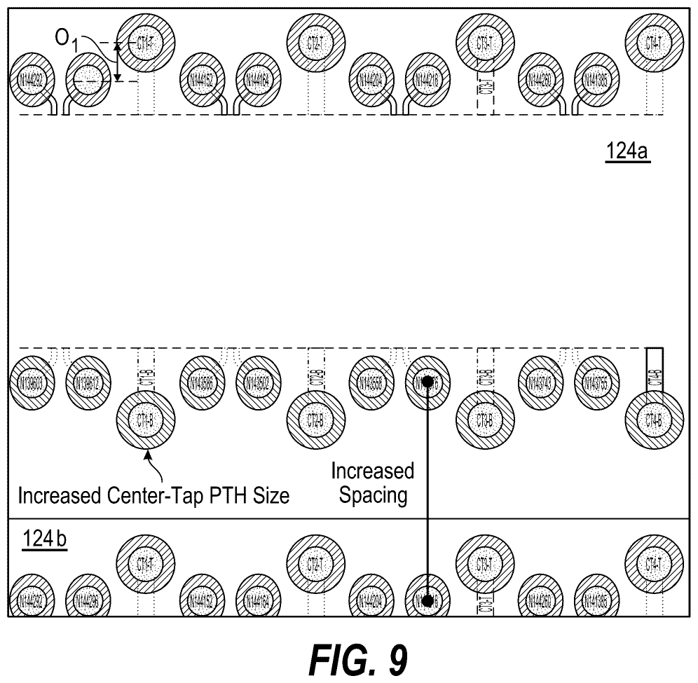

In contrast, FIG. 9 shows a pin diagram of a first substrate 124a positioned adjacent of a second substrate 124b according to various embodiments described herein. Generally, pairs of pins 133 along the first edge 139 or the second edge 142 of the substrate 124a are positioned further from the edge to provide increased spacing between pins 133 on the second substrate 124b. Isolated ones of the pins 133 have an increased center-tap plating through-hole size and/or an increased pin diameter. The pins 133 positioned in pairs (e.g., the first subset of first edge pins 133a) have an offset of relative to the isolated ones of the pins 133 (e.g., the second subset of the first edge pins 133a). In some embodiments, the offset o₁ is 0.5 mm, 1 mm, 1.5 mm, 2 mm, or other dimension that maintains increased performance.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A connector, comprising:
a plurality of substrates positioned proximate to one another, wherein at least one of the plurality of substrates comprises:
a first edge and a second edge opposite the first edge;
a plurality of first edge pins positioned proximate the first edge, wherein a first subset of the first edge pins is positioned at a first distance from the first edge, and a second subset of the first edge pins is positioned at a second distance from the first edge different than the first distance; and
a plurality of second edge pins positioned proximate the second edge, wherein a first subset of the second edge pins is positioned at a first distance from the second edge, and a second subset of the second edge pins is positioned at a second distance from the second edge different than the first distance.

2. The connector according to claim 1, wherein the at least one of the plurality of substrates is a printed circuit board (PCB).

3. The connector according to claim 1, wherein each pin in the first subset of the first edge pins has a diameter less than that of each pin in the second subset of the first edge pins.

4. The connector according to claim 1, wherein each pin in the first subset of the second edge pins has a diameter greater than that of each pin in the second subset of the second edge pins.

5. The connector according to claim 1, wherein each pin of the first edge pins and the second edge pins is positioned within a through-hole.

6. The connector according to claim 1, further comprising:
a first plurality of through-holes positioned proximate the first edge having a first diameter, wherein the first subset of the first edge pins is positioned within the first plurality of through-holes; and
a second plurality of through-holes positioned proximate the first edge having a second diameter different than the first diameter, wherein the second subset of the first edge pins is positioned within the second plurality of through-holes.

7. The connector according to claim 1, further comprising:
a first plurality of through-holes positioned proximate the second edge having a first diameter, wherein the first subset of the second edge pins is positioned within the first plurality of through-holes; and
a second plurality of through-holes positioned proximate the second edge having a second diameter different than the first diameter, wherein the second subset of the second edge pins is positioned within the second plurality of through-holes.

8. The connector according to claim 1, further comprising a plurality of port terminals coupled to the substrate configured to engage with a housing of an external connector.

9. The connector according to claim 8, wherein each of the plurality of substrates comprises electrical traces coupled to one of the plurality of port terminals, wherein the first edge pins and the second edge pins couple the electrical traces to downstream magnetics.

10. The connector according to claim 1, wherein a number of the plurality of port terminals is four, six, or eight, and the external connector is an RJ-45 connector.

11. The connector according to claim 1, wherein:
each pin of the first subset of the first edge pins have a first predetermined offset relative to each pin of the second subset of the first edge pins, wherein the first predetermined offset is a predetermined distance chosen for optimal performance; and
each pin of the first subset of the second edge pins have a second predetermined offset relative to each pin of the second subset of the second edge pins, wherein the second predetermined offset is a predetermined distance chosen for optimal performance.

12. A connector, comprising:
a plurality of substrates positioned proximate to one another, wherein at least one of the plurality of substrates comprises:
a first edge and a second edge opposite the first edge; and
a plurality of first edge pins positioned proximate the first edge, wherein a first subset of the first edge pins is positioned at a first distance from the first edge, and a second subset of the first edge pins is positioned at a second distance from the first edge different than the first distance.

13. The connector according to claim 12, further comprising a plurality of second edge pins positioned proximate the second edge, wherein a first subset of the second edge pins is positioned at a first distance from the second edge, and a second subset of the second edge pins is positioned at a second distance from the second edge different than the first distance.

14. The connector according to claim 12, wherein the at least one of the plurality of substrates is a printed circuit board (PCB).

15. The connector according to claim 12, wherein each pin in the first subset of the first edge pins has a diameter less than that of each pin in the second subset of the first edge pins.

16. The connector according to claim 15, wherein each pin in the first subset of the second edge pins has a diameter greater than that of each pin in the second subset of the second edge pins.

17. The connector according to claim 13, wherein each pin of the first edge pins and the second edge pins is positioned within a through-hole.

18. The connector according to claim 13, further comprising:
a first plurality of through-holes positioned proximate the first edge having a first diameter, wherein the first subset of the first edge pins is positioned within the first plurality of through-holes; and
a second plurality of through-holes positioned proximate the first edge having a second diameter different than the first diameter, wherein the second subset of the first edge pins is positioned within the second plurality of through-holes.

19. The connector according to claim 18, further comprising:
a first plurality of through-holes positioned proximate the second edge having a first diameter, wherein the first subset of the second edge pins is positioned within the first plurality of through-holes; and
a second plurality of through-holes positioned proximate the second edge having a second diameter different than the first diameter, wherein the second subset of the second edge pins is positioned within the second plurality of through-holes.

20. The connector according to claim 12, further comprising a plurality of port terminals coupled to the substrate configured to engage with a housing of an external connector.

21. The connector according to claim 20, wherein each of the plurality of substrates comprises electrical traces coupled to one of the plurality of port terminals, wherein the first edge pins and the second edge pins couple the electrical traces to downstream magnetics.

22. The connector according to claim 21, wherein a number of the plurality of port terminals is four, six, or eight, and the external connector is an RJ-45 connector.

23. The connector according to claim 13, wherein:
each pin of the first subset of the first edge pins have a first predetermined offset relative to each pin of the second subset of the first edge pins, wherein the first predetermined offset is a predetermined distance chosen for optimal performance; and
each pin of the first subset of the second edge pins have a second predetermined offset relative to each pin of the second subset of the second edge pins, wherein the second predetermined offset is a predetermined distance chosen for optimal performance.

24. A connector comprising a substrate, the substrate comprising:
a plurality of first edge pins positioned proximate a first edge is a staggered arrangement, wherein a first subset of the first edge pins is positioned at a first distance from the first edge, and a second subset of the first edge pins is positioned at a second distance from the first edge different than the first distance.
